(19) United States
(12) Patent Application Publication
(10) Pub. No.: US 2026/0028465 A1
(43) Pub. Date: Jan. 29, 2026

(54) SECURITY TAG

(71) Applicants: Murata Manufacturing Co., Ltd., Nagaokakyo-shi (JP); Public University Corporation Nagoya City University, Nagoya-shi (JP)

(72) Inventors: Tatsuya ISHIKAWA, Nagaokakyo-shi (JP); Masaya Nishida, Nagaokakyo-shi (JP); Hironobu Kubota, Nagaokakyo-shi (JP); Nobonu Tanida, Nagaokakyo-shi (JP); Koichiro Hyodo, Nagaokakyo-shi (JP); Masato Sumiyoshi, Nagaokakyo-shi (JP); Junpei Yamanaka, Nagoya-shi (JP); Akiko Toyotama, Nagoya-shi (JP)

(21) Appl. No.: 19/348,152

(22) Filed: Oct. 2, 2025

Related U.S. Application Data
(63) Continuation of application No. PCT/JP2023/045925, filed on Dec. 21, 2023.

(30) Foreign Application Priority Data
Apr. 19, 2023 (JP) 2023-068597

(51) Int. Cl. C08K 3/36; B32B 27/20; B32B 27/30; B42D 25/328

(52) U.S. Cl. CPC C08K 3/36; B32B 27/20; B32B 27/308; B42D 25/328; B32B 2260/025; B32B 2260/046; B32B 2264/101; B32B 2264/201; B32B 2264/301; B32B 2264/302; B32B 2264/303; B32B 2264/503; B32B 2307/418; B32B 2425/00; C08K 2201/005; C08K 2201/011

(57) ABSTRACT

A security tag that includes a resin layer, and a plurality of colloidal particles. The plurality of colloidal particles are embedded in the resin layer and arranged, spaced apart from one another, along a planar direction perpendicular to a thickness direction. The plurality of colloidal particles constitute at least one type of two-dimensional crystal.

### CROSS REFERENCE TO RELATED APPLICATIONS

The present application is a continuation of International application No. PCT/JP2023/045925, filed Dec. 21, 2023, which claims priority to Japanese Patent Application No. 2023-068597, filed Apr. 19, 2023, the entire contents of each of which are incorporated herein by reference.

### TECHNICAL FIELD

The present disclosure relates to a security tag.

### BACKGROUND ART

Patent Literature 1 discloses an anti-counterfeit structure including a microparticle fixing layer that includes spherical microparticles and a microparticle-fixing resin for holding and securing the spherical microparticles. The microparticle-fixing resin includes one or more types of resins and is arranged so that more than half of the heights of the spherical microparticles are not embedded. The spherical microparticles are arranged in a single planar layer, either across the entire surface or in an arbitrary shape, with an area filling rate of 30% or more. Furthermore, the average particle diameter is 2.5 μm or less, and 70% or more of the particles fall within a range of 0.8 to 1.2 times the average particle diameter.
Patent Literature 1: JP 5228666 B

### SUMMARY OF THE DISCLOSURE

The authenticity of the anti-counterfeit structure disclosed in Patent Literature 1 is determined by utilizing a color change that can be observed when the position of the light source or the observation point is shifted.

However, the anti-counterfeit structure disclosed in Patent Literature 1, which relies on the observation of a color change, cannot be made less visible in the visible light spectrum. Thus, the anti-counterfeit structure disclosed in Patent Literature 1 leaves room for improvement in terms of enhancing the anti-counterfeit effect.

The present disclosure has been made to solve the above-mentioned problems, and aims to provide a security tag capable of exhibiting a high anti-counterfeit effect.

The security tag of the present disclosure includes a resin layer, and a plurality of colloidal particles. The plurality of colloidal particles are embedded in the resin layer and arranged, spaced apart from one another, along a planar direction perpendicular to a thickness direction. The plurality of colloidal particles constitute at least one type of two-dimensional crystal.

The present disclosure can provide a security tag capable of exhibiting a high anti-counterfeit effect.

### BRIEF DESCRIPTION OF THE DRAWINGS

FIG. 1 is a schematic plan view of an example security tag of Embodiment 1 of the present disclosure.

FIG. 2 is a schematic cross-sectional view of an example cross section taken along the thickness direction of the security tag shown in FIG. 1.

FIG. 3 is a schematic cross-sectional view of another example cross section taken along the thickness direction of the security tag shown in FIG. 1.

FIG. 4 is a schematic diagram of an example diffraction pattern derived from the two-dimensional crystal shown in FIG. 1.

FIG. 5 is a schematic plan view of an example security tag of Embodiment 2 of the present disclosure.

FIG. 6 is a schematic diagram of an example diffraction pattern derived from the two-dimensional crystal shown in FIG. 5.

FIG. 7 is a schematic plan view of an example security tag of Embodiment 3 of the present disclosure.

### DESCRIPTION OF THE PREFERRED EMBODIMENTS

The security tag of the present disclosure is described below. The present disclosure is not limited to the following preferred embodiments, and may be suitably modified without departing from the gist of the present disclosure. Combinations of two or more preferred features described in the following preferred embodiments are also within the scope of the present disclosure.

The following preferred embodiments are examples, and features of different preferred embodiments can be partially exchanged or combined with each other. In the second preferred embodiment and subsequent preferred embodiments, a description of features common to the first preferred embodiment is omitted, and only different points are described. In particular, similar advantageous effects by similar features are not mentioned in each preferred embodiment.

Hereinbelow, security tags of the following preferred embodiments are referred to simply as “the security tag of the present disclosure” when no distinction is made between the preferred embodiments.

The drawings are schematic drawings, and the dimensions, the aspect ratio, the scale, and other parameters may differ from those of the actual products.

Unless otherwise specified herein, terms indicating relationships between elements (e.g., “parallel”, “perpendicular”) and terms indicating the shapes of elements are not limited to strictly literal embodiments, but also encompass substantially equivalent ranges, including, for example, differences of several percent.

The security tag of the present disclosure includes a resin layer, and a plurality of colloidal particles. The plurality of colloidal particles are embedded in the resin layer and arranged, spaced apart from one another, along a planar direction perpendicular to a thickness direction. The plurality of colloidal particles constitute at least one type of two-dimensional crystal.

The security tag of the present disclosure is used, for example, in security applications such as authenticity determination of items. For example, a manufacturer, distributor, or other similar entities can attach the security tag of the present disclosure to a genuine item in advance. This enables authenticity determination of determining whether a target item is genuine or counterfeit by checking whether or not the security tag of the present disclosure is attached to the target item.

### Embodiment 1

In a security tag of Embodiment 1 of the present disclosure, when observed from the thickness direction, a two-dimensional crystal exhibits six-fold rotational symmetry.

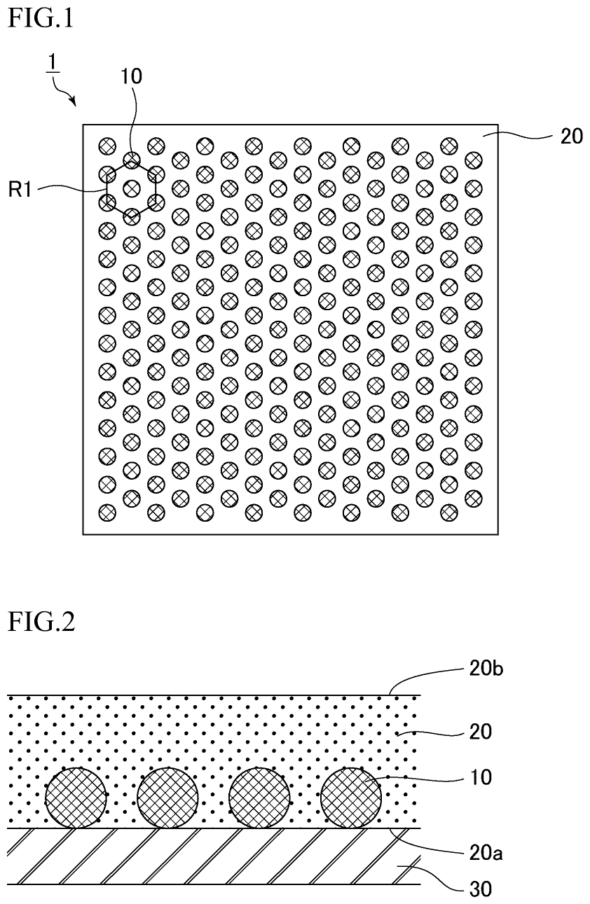

FIG. 1 is a schematic plan view of an example security tag of Embodiment 1 of the present disclosure. FIG. 2 is a schematic cross-sectional view of an example cross section taken along the thickness direction of the security tag shown in FIG. 1.

A security tag 1 shown in FIG. 1 and FIG. 2 includes a plurality of colloidal particles 10 and a resin layer 20.

The colloidal particles 10 are embedded in the resin layer 20. Thereby, the colloidal particles 10 are fixed within the resin layer 20.

Herein, the expression that colloidal particles are embedded in a resin layer refers to a state where 90% or more of the height of the colloidal particles in the thickness direction (the direction perpendicular to the surface of the paper in FIG. 1, or the vertical direction in FIG. 2) is embedded in the resin layer.

In the example shown in FIG. 2, the colloidal particles 10 are completely embedded in the resin layer 20. This allows the colloidal particles 10 to be protected by the resin layer 20.

Embodiments in which the colloidal particles 10 are completely embedded in the resin layer 20 include an embodiment in which the colloidal particles 10 are in contact with the surface of the resin layer 20 from the inside and an embodiment in which the colloidal particles 10 are located inward of the surfaces of the resin layer 20.

The colloidal particles 10 are arranged, spaced apart from one another, along a planar direction perpendicular to the thickness direction. The colloidal particles 10 are not stacked in the thickness direction. In other words, the colloidal particles 10 are arranged two-dimensionally rather than three-dimensionally.

In the security tag 1, the colloidal particles 10 are arranged two-dimensionally while being embedded in the resin layer 20, making the colloidal particles 10 less visible in the visible light spectrum than when the colloidal particles 10 are arranged three-dimensionally. Additionally, in many cases, the resin layer 20 in the security tag 1 is transparent, and thus inherently not readily visible in the visible light spectrum. Therefore, the security tag 1, which includes such colloidal particles 10 and a resin layer 20, is not readily visible in the visible light spectrum.

The security tag 1 is intended to be attached to, for example, valuable items such as paintings and watches. In such cases, the security tag 1 would be attached to the back of a painting or to the back of the frame housing the painting, for example. Similarly, the security tag 1 may be attached to the back of a watch dial, for example. In any of these cases, a third party attempting to counterfeit these valuable items would also need to counterfeit the security tag 1. However, since the security tag 1 is not readily visible in the visible light spectrum, the third party attempting to produce a counterfeit item is unlikely to recognize the presence of the security tag 1. Consequently, the third party is unlikely to attempt to incorporate the security tag 1 into a counterfeit item, thereby reducing the likelihood of producing a fully counterfeit item that includes the security tag 1.

Therefore, the security tag 1, which is not readily visible in the visible light spectrum, can exhibit a high anti-counterfeit effect.

Additionally, in the security tag 1, the colloidal particles 10 constitute a two-dimensional crystal R1.

When observed from the thickness direction, the two-dimensional crystal R1 exhibits six-fold rotational symmetry.

The rotational symmetry of the two-dimensional crystal, when observed from the thickness direction, is confirmed based on the diffraction pattern described later.

The effect of the presence of the two-dimensional crystal R1 in the security tag 1 is described below with reference to an example method for producing the security tag 1.

The security tag 1 is produced through the following procedure, for example.

First, a colloidal dispersion in which the colloidal particles 10 are dispersed in a dispersion medium is prepared.

Examples of the dispersion medium include inorganic solvents such as water and organic solvents such as alcohols.

Next, the colloidal dispersion is, for example, applied and left to stand on the surface of a base such as a glass plate. As a result, the colloidal particles 10 are arranged two-dimensionally on the surface of the base while being spaced apart from one another due to electrostatic repulsion.

Subsequently, the dispersion medium in the colloidal dispersion is dried, and then the resin layer 20 is formed on the surface of the base such that the colloidal particles 10 remaining on the surface of the base are embedded in the resin layer 20.

Thereby, the security tag 1 is produced.

In the thus-produced security tag 1, the colloidal particles 10 are arranged two-dimensionally while being spaced apart from one another, forming the two-dimensional crystal R1. In the thus-produced security tag 1, the two-dimensional crystal R1 is formed due to electrostatic repulsion between the colloidal particles 10, and is therefore a unique and unreproducible two-dimensional crystal. Accordingly, it is impossible to produce a counterfeit security tag with a two-dimensional crystal that is perfectly identical to the two-dimensional crystal R1.

As a result, the security tag 1 with the two-dimensional crystal R1 can exhibit a high anti-counterfeit effect.

Consequently, the security tag 1, which is not readily visible in the visible light spectrum and includes the two-dimensional crystal R1, can realize a security tag capable of exhibiting a high anti-counterfeit effect.

Preferably, when observed from the thickness direction, the colloidal particles 10 are present throughout the entire security tag 1.

When observed from the thickness direction, the colloidal particles 10 may be present in some regions in the security tag 1. In other words, when observed from the thickness direction, the colloidal particles 10 may be absent in some regions in the security tag 1.

Preferably, when observed from the thickness direction, the colloidal particles 10 are regularly spaced such that the inter-center distance (pitch) between adjacent colloidal particles 10 in the planar direction is constant. In such a case, when observed from the thickness direction, the colloidal particles 10 may be regularly spaced throughout the entire security tag 1 or in some regions in the security tag 1.

The resin layer 20 includes a first surface 20a and a second surface 20b which face each other in the thickness direction. Here, the colloidal particles 10 may be present closer to the first surface 20a of the resin layer 20 than to the second surface 20b of the resin layer 20. In other words, the distance between the colloidal particles 10 and the first surface 20a of the resin layer 20 may be less than the distance between the colloidal particles 10 and the second surface 20b of the resin layer 20.

The colloidal particles 10 may also be present closer to the second surface 20b of the resin layer 20 than to the first surface 20a of the resin layer 20. In other words, the distance between the colloidal particles 10 and the first surface 20a of the resin layer 20 may be greater than the distance between the colloidal particles 10 and the second surface 20b of the resin layer 20.

The colloidal particles 10 may also be present midway between the first surface 20a and the second surface 20b of the resin layer 20. In other words, the distance between the colloidal particles 10 and the first surface 20a of the resin layer 20 may be the same as the distance between the colloidal particles 10 and the second surface 20b of the resin layer 20.

Preferably, sets of the colloidal particles 10 have the same average particle diameter.

Herein, the expression “having the same average particle diameter” means that the ratio of the average particle diameters is 0.97 to 1.03.

All of the sets or one or more of the sets of the colloidal particles 10 may have different average particle diameters.

Herein, the expression “having different average particle diameters” means that the ratio of the average particle diameters is less than 0.97 or greater than 1.03.

Preferably, the colloidal particles 10 have an average particle diameter of 1 nm to 50 μm.

The average particle diameter of a set of colloidal particles is measured using a scanning electron microscope (SEM) on 100 to 200 colloidal particles selected from among all the colloidal particles included in the security tag.

The colloidal particles 10 may be inorganic particles or organic particles.

In the case where the colloidal particles 10 are inorganic particles, the material thereof may be, for example, silica, titanium oxide, alumina, gold, or silver. Silica and titanium oxide are particularly preferred.

In the case where the colloidal particles 10 are organic particles, the material thereof may be, for example, a polymer such as polystyrene, a polyacrylate ester, a polymethacrylate ester, or polyacrylonitrile. Polystyrene is particularly preferred.

Preferably, the resin layer 20 includes an ultraviolet-curable resin.

Examples of the material of the resin layer 20 include polymer resins such as acrylic resins, epoxy resins, polyurethane resins, and polystyrene resins, silicone resins, and biopolymers. Among these resins, acrylic resins are preferred. Among the acrylic resins, polydialkylacrylamide is preferred. When the resin layer 20 includes polydialkylacrylamide and the colloidal particles 10 are silica particles, the resin layer 20 tends to adsorb onto the colloidal particles 10, thereby facilitating the fixation of the colloidal particles 10 within the resin layer 20.

In the visible light spectrum, the refractive index of the colloidal particles 10 may be the same as the refractive index of the resin layer 20. In such a case, the security tag 1 is completely invisible in the visible light spectrum. This enhances the anti-counterfeit effect of the security tag 1.

When the security tag 1 is completely invisible in the visible light spectrum, a third party attempting to produce counterfeit items would fail to recognize the presence of the security tag 1. As a result, the third party would not incorporate the security tag 1 into a counterfeit item, and thus would not produce a fully counterfeit item including the security tag 1. Furthermore, making the security tag 1 completely invisible prevents the security tag 1 from adversely affecting the appearance (design) of an item.

Herein, the visible light spectrum refers to the wavelength range of 360 nm or longer and 830 nm or shorter.

Herein, the expression that the refractive indexes in the visible light spectrum are the same refers to a condition in which the ratio of the refractive indexes in the visible light spectrum is 0.95 to 1.05.

In the visible light spectrum, the refractive index of the colloidal particles 10 may differ from the refractive index of the resin layer 20.

Herein, the expression that the refractive indexes in the visible light spectrum differ refers to a condition in which the ratio of the refractive indexes in the visible light spectrum is less than 0.95 or greater than 1.05.

Preferably, the refractive index of the colloidal particles 10 in the visible light spectrum is 1.3 to 2.3.

Preferably, the refractive index of the resin layer 20 in the visible light spectrum is 1.3 to 2.3.

The refractive indexes of the colloidal particles and the resin layer in the visible light spectrum are measured using the V-block method.

In the infrared light spectrum, the refractive index of the colloidal particles 10 may differ from the refractive index of the resin layer 20. In this case, the security tag 1 becomes detectable in the infrared light spectrum.

Herein, the infrared light spectrum refers to the wavelength range of 830 nm or longer and 1 mm or shorter.

Herein, the expression that the refractive indexes in the infrared light spectrum differ refers to a condition in which the ratio of the refractive indexes in the infrared light spectrum is less than 0.95 or greater than 1.05.

In the infrared light spectrum, the refractive index of the colloidal particles 10 may be the same as the refractive index of the resin layer 20.

Herein, the expression that the refractive indexes in the infrared light spectrum are the same refers to a condition in which the ratio of the refractive indexes in the infrared light spectrum is 0.95 to 1.05.

Preferably, the refractive index of the colloidal particles 10 in the infrared light spectrum is 0.4 to 5.7.

Preferably, the refractive index of the resin layer 20 in the infrared light spectrum is 0.4 to 5.7.

The refractive indexes of the colloidal particles and the resin layer in the infrared light spectrum are measured using the V-block method.

In the security tag 1, in the visible light spectrum, the refractive index of the colloidal particles 10 is the same as the refractive index of the resin layer 20, and in the infrared light spectrum, the refractive index of the colloidal particles 10 differs from the refractive index of the resin layer 20. This makes the security tag 1 invisible (undetectable) in the visible light spectrum and detectable in the infrared light spectrum. In this case, a third party attempting to produce counterfeit items would be unable to recognize the presence of the security tag 1. Even if the third party recognized the presence of the security tag 1, they would be unable to produce a counterfeit item of the security tag 1, in which the unique and unreproducible two-dimensional crystal R1 is present and the refractive index of the colloidal particles 10 differs from the refractive index of the resin layer 20 in the infrared light spectrum.

When the security tag 1 is detectable in the infrared light spectrum, the security tag 1 can be attached, for example, to the back or another part of a painting, or to the back or another part of a watch dial. This prevents the security tag 1 from being visible from the front of the painting, watch, or similar item. Even in such cases, since infrared light (infrared rays) can pass through materials such as glass and plastic, the security tag 1 remains detectable in the infrared light spectrum.

In the security tag 1, when the refractive index of the colloidal particles 10 is the same as the refractive index of the resin layer 20 in the visible light spectrum, the refractive index of the colloidal particles 10 may be the same as or different from the refractive index of the resin layer 20 in the infrared light spectrum. For example, in the security tag 1, when the refractive index of the colloidal particles 10 is the same as the refractive index of the resin layer 20 in the visible light spectrum and the refractive index of the colloidal particles 10 is the same as the refractive index of the resin layer 20 in the infrared light spectrum, the low visibility of the security tag 1 is secured, although the detectability of the security tag 1 may possibly be reduced.

In the security tag 1, when the refractive index of the colloidal particles 10 differs from the refractive index of the resin layer 20 in the visible light spectrum, i.e., when the security tag 1 is detectable in the visible light spectrum, then in the infrared light spectrum, the refractive index of the colloidal particles 10 may be the same as or different from the refractive index of the resin layer 20. This is because when detection of the security tag 1 in the infrared light spectrum is not intended, the relationship between the refractive indexes of the colloidal particles 10 and the resin layer 20 in the infrared light spectrum does not affect the detectability of the security tag 1.

As shown in FIG. 2, the security tag 1 may further include a base 30 disposed in contact with the first surface 20a of the resin layer 20.

With the base 30 included in the security tag 1, the colloidal particles 10 are protected by not only the resin layer 20 but also the base 30.

In the example shown in FIG. 2, the colloidal particles 10 are present closer to the first surface 20a of the resin layer 20 than to the second surface 20b of the resin layer 20. Specifically, the colloidal particles 10 are in contact with the first surface 20a of the resin layer 20 from the inside. Additionally, in the example shown in FIG. 2, the base 30 is in contact with the first surface 20a of the resin layer 20. Therefore, in the example shown in FIG. 2, the base 30 is in contact with the colloidal particles 10.

The configuration in which the base 30 is in contact with the colloidal particles 10 as shown in FIG. 2 can be realized, for example, by using the base 30 as the base to which the colloidal dispersion including the colloidal particles 10 is applied and on which the colloidal dispersion including the colloidal particles 10 is left to stand during the production of the security tag 1 by the method described above.

Examples of the base 30 include transparent plates such as glass plates and plastic plates.

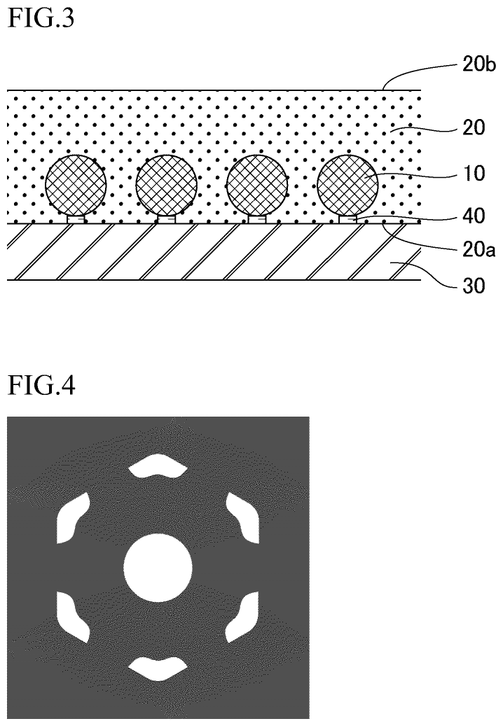

FIG. 3 is a schematic cross-sectional view of another example cross section taken along the thickness direction of the security tag shown in FIG. 1.

As shown in FIG. 3, the security tag 1 may further include an intermediate layer 40 interposed between the colloidal particles 10 and the base 30.

In the example shown in FIG. 3, the colloidal particles 10 are present closer to the first surface 20a of the resin layer 20 than to the second surface 20b of the resin layer 20. Specifically, the colloidal particles 10 are located inward of the first surface 20a of the resin layer 20. In other words, in the example shown in FIG. 3, the colloidal particles 10 are spaced apart from the first surface 20a of the resin layer 20. Furthermore, in the example shown in FIG. 3, the base 30 is in contact with the first surface 20a of the resin layer 20. Therefore, in the example shown in FIG. 3, the colloidal particles 10 and the base 30 are spaced apart from each other. In the above configuration, the intermediate layer 40 is interposed between the colloidal particles 10 and the first surface 20a of the resin layer 20, i.e., between the colloidal particles 10 and the base 30.

With the intermediate layer 40 interposed between the colloidal particles 10 and the base 30, the colloidal particles 10 are fixed onto the base 30 via the intermediate layer 40. With the colloidal particles 10 fixed onto the base 30, the structure of the two-dimensional crystal R1 including the colloidal particles 10 is likely to be maintained even when, for example, external force is applied to the security tag 1.

The configuration in which the intermediate layer 40 is interposed between the colloidal particles 10 and the base 30 as shown in FIG. 3 can be realized, for example, by using the base 30 on which the intermediate layer 40 has been previously formed, as the base to which the colloidal dispersion including the colloidal particles 10 is applied and on which the colloidal dispersion including the colloidal particles 10 is left to stand during the production of the security tag 1 by the method described above. When the colloidal dispersion is applied and left to stand on the surface of the base 30 on which the intermediate layer 40 has been previously formed, the colloidal particles 10 become arranged two-dimensionally while being adsorbed onto the intermediate layer 40.

The thickness of the intermediate layer 40 is 1 nm to 100 nm, for example. In other words, when the colloidal particles 10 are spaced apart from the first surface 20a of the resin layer 20, the distance between the colloidal particles 10 and the first surface 20a of the resin layer 20 is 1 nm to 100 nm, for example. Also, when the colloidal particles 10 are spaced apart from the base 30, the distance between the colloidal particles 10 and the base 30 is 1 nm to 100 nm, for example.

Examples of the material of the intermediate layer 40 include silane-coupling agents.

The security tag 1 is used, for example, for determination of the authenticity of items through the following procedure.

When the security tag 1 is irradiated with light, a diffraction pattern derived from the two-dimensional crystal R1 appears. In the example shown in FIG. 1, since the two-dimensional crystal R1 exhibits six-fold rotational symmetry, the six-fold rotational symmetrical diffraction pattern as shown in FIG. 4 appears. FIG. 4 is a schematic diagram of an example diffraction pattern derived from the two-dimensional crystal shown in FIG. 1. Such detection of the diffraction pattern allows detection of the security tag 1, which is not readily visible in the visible light spectrum.

Furthermore, since the two-dimensional crystal R1 is a unique and unreproducible two-dimensional crystal, a diffraction pattern derived from the two-dimensional crystal R1 is also a unique and unreproducible diffraction pattern. In this manner, a unique diffraction pattern defined by the arrangement, particle diameter, and other conditions of the colloidal particles 10 constituting the two-dimensional crystal R1 is detected from the security tag 1 with the two-dimensional crystal R1.

Accordingly, when the security tag 1 is attached to a genuine item, the authenticity of the target items can be determined through the following procedure, for example.

First, when a target item is irradiated with light, whether or not a diffraction pattern derived from a two-dimensional crystal is detected is determined, thereby determining whether or not a security tag of the same type as the security tag 1 is attached to the target item. Then, when a determination is made that a security tag is attached to the target item, whether or not the diffraction pattern detected from the target item matches the diffraction pattern unique to the security tag 1 attached to the genuine item is determined. Thereby, it is determined whether or not the security tag attached to the target item matches the security tag 1 attached to the genuine item.

In the detection of the security tag 1, the main surface of the security tag 1 may be irradiated with light from a perpendicular direction (incident angle: 90°) or from a different direction (incident angle: other than 90°).

In the detection of the security tag 1, reflected light from the security tag 1 upon irradiation of the security tag 1 with light may be used to detect the diffraction pattern.

In the detection of the security tag 1, transmitted light through the security tag 1 upon irradiation of the security tag 1 with light maybe used to detect the diffraction pattern.

In the detection of the security tag 1, the main surface of the security tag 1 may be irradiated with light from a perpendicular direction (incident angle: 90°), and the reflected light from the security tag 1 in the perpendicular direction may be detected, thereby allowing detection of the diffraction pattern. This configuration in the detection of the security tag 1 allows positional alignment of the light source for irradiating the security tag 1 with light and the detector for detecting reflected light from the security tag 1. For example, the light source and the detector can be integrated.

On the contrary, the technique disclosed in Patent Literature 1 detects the anti-counterfeit structure by utilizing a color change that can be observed when the position of the light source or the observation point is shifted. Accordingly, the technique disclosed in Patent Literature 1 cannot detect the anti-counterfeit structure without such a positional shift of the light source or the observation point, for example, in a state where the light source and the observation point are positionally aligned.

Consequently, in the detection of the security tag 1, unlike in the case of detecting the anti-counterfeit structure disclosed in Patent Literature 1, conditions such as the positional relationship between the light source and the detector are not limited.

### Embodiment 2

In a security tag of Embodiment 2 of the present disclosure, when observed from the thickness direction, a two-dimensional crystal exhibits four-fold rotational symmetry.

The security tag of Embodiment 2 of the present disclosure is the same as the security tag of Embodiment 1 of the present disclosure, except in the above respect.

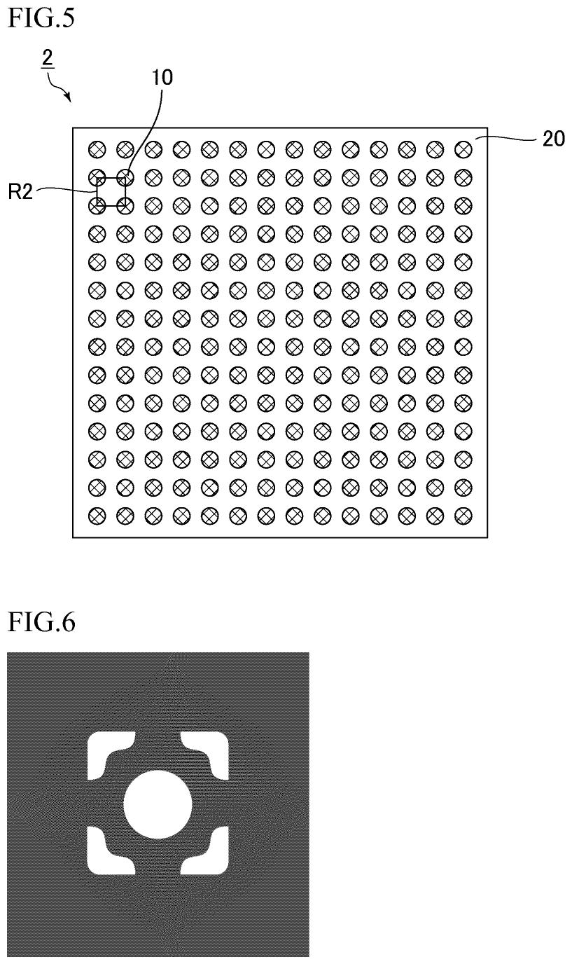

FIG. 5 is a schematic plan view of an example security tag of Embodiment 2 of the present disclosure.

In a security tag 2 shown in FIG. 5, the colloidal particles 10 constitute a two-dimensional crystal R2.

When observed from the thickness direction, the two-dimensional crystal R2 exhibits four-fold rotational symmetry.

When the security tag 2 is irradiated with light, a diffraction pattern derived from the two-dimensional crystal R2, which corresponds here to the four-fold rotational symmetrical diffraction pattern as shown in FIG. 6, appears. FIG. 6 is a schematic diagram of an example diffraction pattern derived from the two-dimensional crystal shown in FIG. 5.

The two-dimensional crystal R2 exhibiting four-fold rotational symmetry is more challenging to realize than the two-dimensional crystal R1 exhibiting six-fold rotational symmetry. Therefore, the security tag 2 with the two-dimensional crystal R2 exhibiting four-fold rotational symmetry can exert a higher anti-counterfeit effect than the security tag 1 with the two-dimensional crystal R1 exhibiting six-fold rotational symmetry.

The two-dimensional crystal R2 exhibiting four-fold rotational symmetry can be realized, for example, by adjusting the thickness of the colloidal dispersion applied and left to stand on the surface of the base during the production of the security tag 2 using the same method as used for the security tag 1. For example, after the colloidal dispersion is applied and left to stand on the surface of the base, a different base such as a glass plate can be placed on top of the colloidal dispersion to change the thickness of the colloidal dispersion. In this process, changing the thickness of the different base to be placed on top of the colloidal dispersion allows a change in the weight of the different base, thereby allowing adjustment of the thickness of the colloidal dispersion. With the thickness of the colloidal dispersion falling within a specific range, the two-dimensional crystal R2 exhibiting four-fold rotational symmetry can be realized.

Hereinabove, an embodiment (Embodiment 1) in which the two-dimensional crystal present in the security tag of the present disclosure exhibits six-fold rotational symmetry when observed from the thickness direction and an embodiment (Embodiment 2) in which the two-dimensional crystal exhibits four-fold rotational symmetry when observed from the thickness direction have been described. However, the two-dimensional crystal present in the security tag of the present disclosure may exhibit symmetry other than the six-fold rotational symmetry and four-fold rotational symmetry when observed from the thickness direction.

### Embodiment 3

A security tag of Embodiment 3 of the present disclosure includes a plurality of types of two-dimensional crystals.

In the security tag of Embodiment 3 of the present disclosure, the orientations of the symmetry axes along the planar direction of the plurality of types of two-dimensional crystals are different from one another.

The security tag of Embodiment 3 of the present disclosure is the same as the security tags of Embodiment 1 and Embodiment 2 of the present disclosure, expect in the above respect.

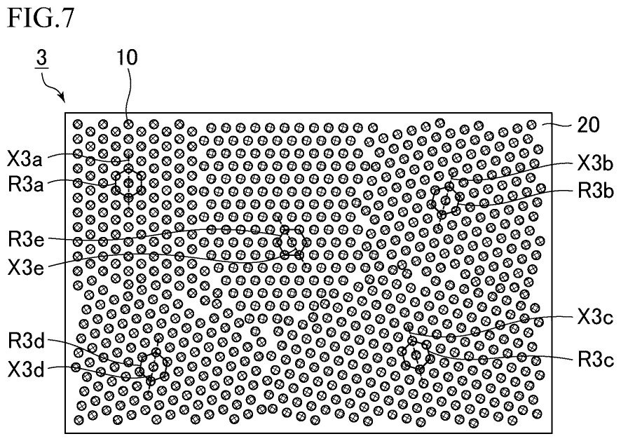

FIG. 7 is a schematic plan view of an example security tag of Embodiment 3 of the present disclosure.

In a security tag 3 shown in FIG. 7, the colloidal particles 10 constitute a two-dimensional crystal R3a, a two-dimensional crystal R3b, a two-dimensional crystal R3c, a two-dimensional crystal R3d, and a two-dimensional crystal R3e.

The two-dimensional crystal R3a, the two-dimensional crystal R3b, the two-dimensional crystal R3c, the two-dimensional crystal R3d, and the two-dimensional crystal R3e each exhibit six-fold rotational symmetry when observed from the thickness direction.

The two-dimensional crystal R3a, the two-dimensional crystal R3b, the two-dimensional crystal R3c, the two-dimensional crystal R3d, and the two-dimensional crystal R3e may each exhibit symmetry other than six-fold rotational symmetry, such as, for example, four-fold rotational symmetry, when observed from the thickness direction.

The two-dimensional crystal R3a, the two-dimensional crystal R3b, the two-dimensional crystal R3c, the two-dimensional crystal R3d, and the two-dimensional crystal R3e respectively include, as their symmetry axes along the planar direction, a symmetry axis X3a, a symmetry axis X3b, a symmetry axis X3c, a symmetry axis X3d, and a symmetry axis X3e.

Herein, a symmetry axis along a planar direction refers to a symmetry axis along a planar direction when the two-dimensional crystal exhibits line symmetry when observed from the thickness direction.

The orientations of the symmetry axis X3a, the symmetry axis X3b, the symmetry axis X3c, the symmetry axis X3d, and the symmetry axis X3e are different from one another.

In the security tag 3, when the types of two-dimensional crystals are classified based on the orientation of their symmetry axes along a planar direction, five types of two-dimensional crystals with different orientations of their symmetry axes along a planar direction, namely the two-dimensional crystal R3a, the two-dimensional crystal R3b, the two-dimensional crystal R3c, the two-dimensional crystal R3d, and the two-dimensional crystal R3e, are present.

The two-dimensional crystal R3a, the two-dimensional crystal R3b, the two-dimensional crystal R3c, the two-dimensional crystal R3d, and the two-dimensional crystal R3e are each a unique and unreproducible two-dimensional crystal, and each combination of any of the orientations of their symmetry axes along a planar direction is a unique and unreproducible combination. Accordingly, the security tag 3 with the two-dimensional crystal R3a, the two-dimensional crystal R3b, the two-dimensional crystal R3c, the two-dimensional crystal R3d, and the two-dimensional crystal R3e can exhibit an even higher anti-counterfeit effect.

The number of types of two-dimensional crystals present in the security tag 3 is not limited to five and may be any other number greater than or equal to two.

In Embodiment 3, the types of two-dimensional crystals in the security tag of the present disclosure are classified based on the orientation of their symmetry axes along a planar direction. However, the types of two-dimensional crystals may be classified based on the symmetry when observed from the thickness direction, or may be classified based on any other characteristics.

For example, in the security tag of the present disclosure, in cases where the types of two-dimensional crystals are classified based on the symmetry when observed from the thickness direction, a plurality of types of two-dimensional crystals may be present which exhibit different symmetries when observed from the thickness direction. In such cases, in the security tag of the present disclosure, for example, a two-dimensional crystal exhibiting six-fold rotational symmetry when observed from the thickness direction (Embodiment 1) and a two-dimensional crystal exhibiting four-fold rotational symmetry when observed from the thickness direction (Embodiment 2) may be present together. Including the two-dimensional crystal exhibiting four-fold rotational symmetry when observed from the thickness direction, the security tag of the present disclosure can exhibit an even higher anti-counterfeit effect.

For a diffraction pattern derived from a two-dimensional crystal present in the security tag of the present disclosure, information such as the shape, size, position, and orientation of its symmetry axis along a planar direction, and information such as diffraction patterns that appear when light is applied at various incident angles can be encoded. The encoded information can be used to identify the security tag, thereby allowing the determination of the authenticity of an item.

The security tag of the present disclosure may be in any form, such as, for example, a film, a card, or a sticker.

### REFERENCE SIGNS LIST

1, 2, 3: security tag
10: colloidal particles
20: resin layer
20a: first surface of resin layer
20b: second surface of resin layer
30: base
40: intermediate layer
R1, R2, R3a, R3b, R3c, R3d, R3e: two-dimensional crystal
X3a, X3b, X3c, X3d, X3e: symmetry axis

1. A security tag comprising:
a resin layer; and
a plurality of colloidal particles embedded in the resin layer and arranged, spaced apart from one another, along a planar direction perpendicular to a thickness direction,
wherein the plurality of colloidal particles constitute at least one type of two-dimensional crystal,
the at least one type of two-dimensional crystal comprises a plurality of types of two-dimensional crystals, and
orientations of symmetry axes along the planar direction of the plurality of types of two-dimensional crystals are different from one another.

2. The security tag according to claim 1, wherein the plurality of colloidal particles are completely embedded in the resin layer.

3. The security tag according to claim 1, wherein the plurality of colloidal particles are not stacked in the thickness direction.

4. The security tag according to claim 1, wherein when observed from the thickness direction, the plurality of colloidal particles are regularly spaced such that an inter-center distance between adjacent colloidal particles in the planar direction is constant.

5. The security tag according to claim 1, wherein the plurality of colloidal particles have an average particle diameter of 1 nm to 50 μm.

6. The security tag according to claim 1, wherein
a material of the resin layer comprises an acrylic resin; and
a material of the plurality of colloidal particles is silica.

7. The security tag according to claim 1, wherein, in a visible light spectrum, a refractive index of the plurality of colloidal particles is the same as a refractive index of the resin layer.

8. The security tag according to claim 1, wherein, in an infrared light spectrum, a refractive index of the plurality of colloidal particles is different from a refractive index of the resin layer.

9. The security tag according to claim 1, wherein when observed from the thickness direction, the at least one type of two-dimensional crystal exhibits six-fold rotational symmetry.

10. The security tag according to claim 1, wherein when observed from the thickness direction, the at least one type of two-dimensional crystal exhibits four-fold rotational symmetry.

11. The security tag according to claim 1,
wherein the resin layer includes a first surface and a second surface which face each other in the thickness direction, and
the plurality of colloidal particles are present closer to the first surface of the resin layer than to the second surface of the resin layer.

12. The security tag according to claim 11, further comprising a base in contact with the first surface of the resin layer.

13. The security tag according to claim 12, wherein the base is in contact with the plurality of colloidal particles.

14. The security tag according to claim 12, further comprising an intermediate layer interposed between the plurality of colloidal particles and the base.

15. The security tag according to claim 14, wherein a material of the intermediate layer comprises a silane-coupling agent.
